(19) United States
(12) Patent Application Publication
(10) Pub. No.: US 2017/0191517 A1
(43) Pub. Date: Jul. 6, 2017

(54) Mounting System Employing an X-Shaped Adapter for Mounting Devices to a Square Receiver

(71) Applicant: Troy Bengtzen, Holladay, UT (US)

(72) Inventor: Troy Bengtzen, Holladay, UT (US)

(21) Appl. No.: 15/398,632

(22) Filed: Jan. 4, 2017

Related U.S. Application Data
(60) Provisional application No. 62/274,714, filed on Jan. 4, 2016.

(51) Int. Cl. F16B 13/04

(52) U.S. Cl. CPC F16B 13/04

(57) ABSTRACT

A mounting system employs an X-shaped adapter for mounting a device to a square receiver. Many different devices can include an X-shaped adapter to allow the device to be mounted to any appropriately sized square receiver. A square receiver can be positioned and secured in many different locations to facilitate the use of a variety of devices in such locations. The X-shaped adapter is configured to insert within the opening of the square receiver when the X is aligned with the corners of the opening. Once inserted, the X-shape prevents the device from rotating.

### CROSS-REFERENCE TO RELATED APPLICATIONS

This application claims priority to U.S. Provisional Patent Application No. 62/274,714 which was filed on Jan. 4, 2016.

### BRIEF SUMMARY

The present invention is generally directed to a mounting system which employs an X-shaped adapter for mounting a device to a square receiver. Many different devices can include an X-shaped adapter to allow the device to be mounted to any appropriately sized square receiver. A square receiver can be positioned and secured in many different locations to facilitate the use of a variety of devices in such locations.

The X-shaped adapter is configured to insert within a square opening of the square receiver when the X is aligned with the corners of the opening. Once inserted, the X-shape prevents the device from rotating. The X-shape also provides substantial structural integrity to the adapter thereby allowing heavy devices or devices that create substantial forces during use to be mounted to the square receiver. The X-shape also facilitates inserting the adapter into the receiver because the X can be configured so that a perfect alignment is not required while still preventing rotation between the adapter and receiver.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example of a square receiver and corresponding X-shaped adapter in accordance with one or more embodiments of the invention;

FIG. 1A illustrates a top view of the square receiver of FIG. 1;

FIG. 1B illustrates a bottom view of the X-shaped adapter of FIG. 1;

FIG. 2 illustrates the square receiver and X-shaped adapter of FIG. 1 when the X-shaped adapter has been inserted into the receiver;

FIG. 2A illustrates a cross-sectional top view of the X-shaped adapter within the receiver;

FIG. 3 illustrates an example device having an X-shaped adapter; and

FIG. 4 provides a picture of a first square receiver that is secured to a post of a cart that also forms a second square receiver.

### DETAILED DESCRIPTION

The present invention is generally directed to a mounting system which employs an X-shaped adapter for mounting a device to a square receiver. Many different devices can include an X-shaped adapter to allow the device to be mounted to any appropriately sized square receiver. A square receiver can be positioned and secured in many different locations to facilitate the use of a variety of devices in such locations.

The X-shaped adapter is configured to insert within a square opening of the square receiver when the X is aligned with the corners of the opening. Once inserted, the X-shape prevents the device from rotating. The X-shape also provides substantial structural integrity to the adapter thereby allowing heavy devices or devices that create substantial forces during use to be mounted to the square receiver. The X-shape also facilitates inserting the adapter into the receiver because the X can be configured so that a perfect alignment is not required while still preventing rotation between the adapter and receiver.

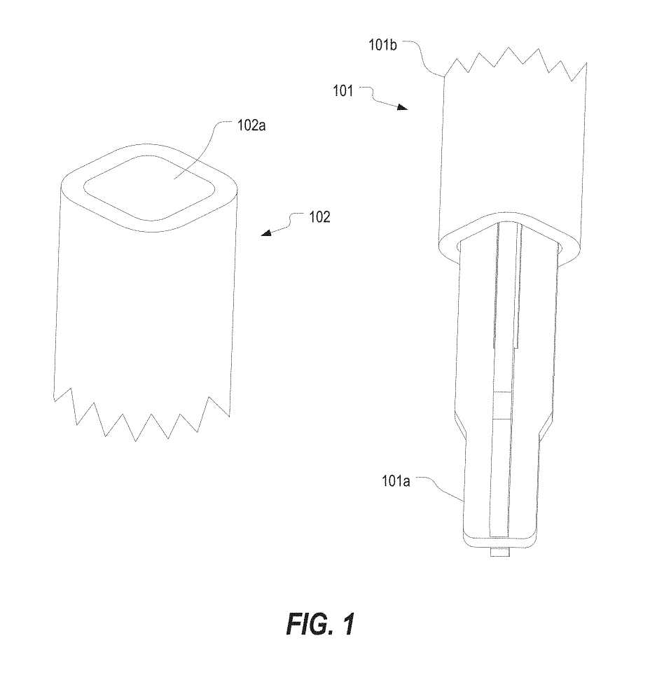

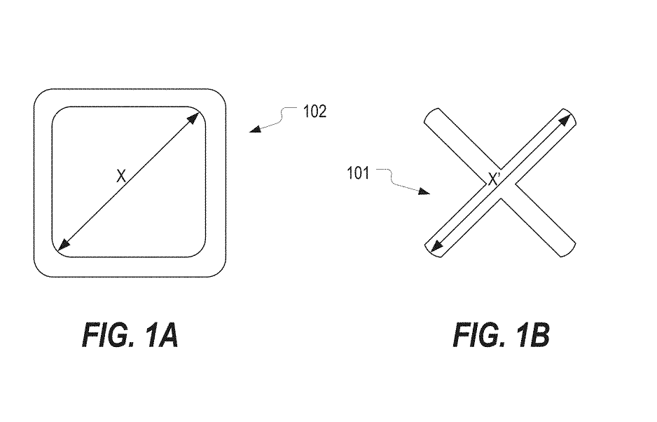

FIG. 1 illustrates an example of an X-shaped adapter 101 and a square receiver 102 in accordance with one or more embodiments of the invention. X-shaped adapter 101 generally comprises an adapter portion 101a and a device portion 101b. Adapter portion 101a is configured as an elongated X-shape. Square receiver 102 comprises an opening 102a that is also a square shape.

FIG. 1A illustrates a top view of square receiver 102 while FIG. 1B illustrates a bottom view of X-shaped adapter 101. As shown, square receiver 102 has an internal diagonal dimension X while X-shaped adapter 101 has a diagonal dimension X′ with X′ being slightly smaller than X. In this manner, X-shaped adapter 101 can be inserted within opening 102a when the X is aligned with the corners of the opening. Once inserted, the X-shape prevents X-shaped adapter 101 from rotating within square receiver 102. Although this specification describes the receiver as being square, in some embodiments, a rectangular receiver and corresponding adapter having a rectangular-shaped X can be employed.

In FIG. 1, the adapter portion 101a is shown as having a narrowed tip. The narrowed tip can facilitate inserting the adapter portion within the opening 102a of square receiver 102. For example, the narrowed tip can allow the adapter portion to be initially inserted even when the X-shape is not aligned. Then, as the adapter portion is further inserted into the opening, the X-shape will naturally align with the corners of the opening.

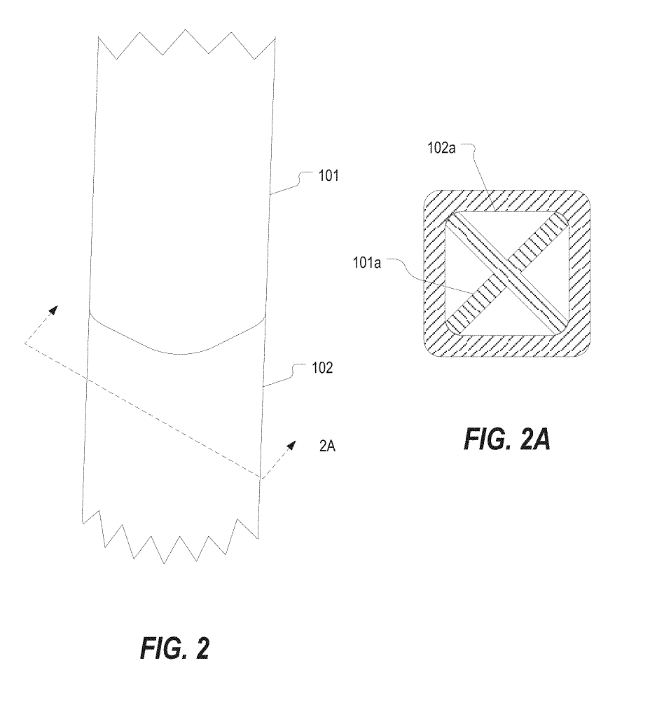

FIG. 2 illustrates X-shaped adapter 101 inserted within square receiver 102. As shown in the cross-sectional top view of FIG. 2A, adapter portion 101a is positioned within opening 102a with the X-shape being aligned at the corners of the opening. In this position, X-shaped adapter 101 will be prevented from rotating with respect to receiver 102. The X-shape also functions to provide additional cross support to the square shape of the receiver thereby enabling the receiver to be used to support heavy devices or devices that generate substantial forces during use.

Returning to FIG. 1, device portion 101b of X-shaped adapter 101 can be integrally formed with adapter portion 101a. In some embodiments, device portion 101b can comprise the body of a device or can comprise a device adapter to which another device attaches. Accordingly, a device can be integrally formed with an adapter portion 101a, or can be configured to attach to a device adapter that is integrally formed with an adapter portion 101a.

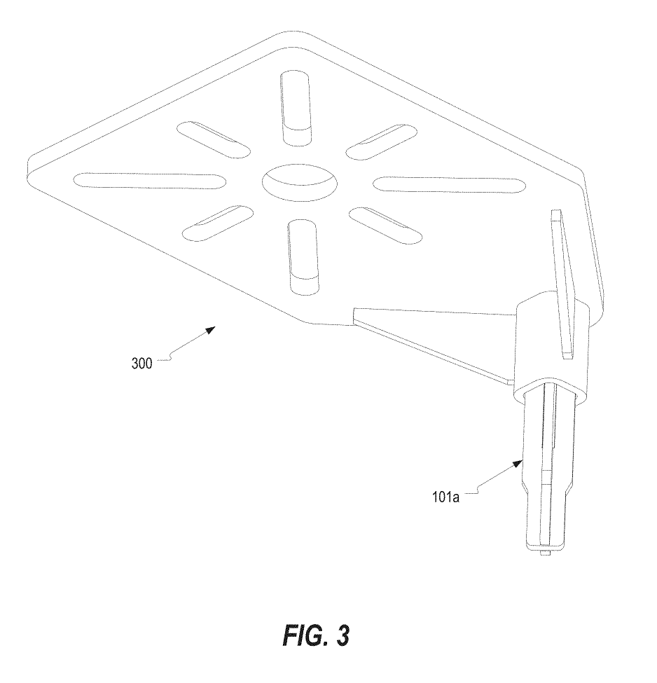

FIG. 3 illustrates an example of a device 300 that includes an integrally formed adapter portion 101a. Device 300 comprises a universal mounting plate to which a number of different devices may be attached. For example, a vise, pipe vise, bench grinder, etc. can be attached to device 300. Because device 300 comprises an X-shaped adapter 101, device 300 can be mounted to any appropriately sized square receiver 102. Accordingly, any of the devices that can be attached to device 300 can be mounted for use wherever an appropriately sized square receiver 102 may be located.

Additionally, many devices that could be attached to device 300 or another similar device adapter could alternatively be configured to include an integral adapter portion 101a as described above. In such cases, these devices could be mounted directly to a square receiver 102 without requiring any device adapter. Accordingly, a device should be construed broadly to include any item that includes an X-shaped adapter 101 whether the item is the actual device, or a device adapter that includes an X-shaped adapter 101.

In accordance with embodiments of the invention, a square receiver 102 can be positioned in virtually any location. For example, a square receiver 102 can be configured to attach to the floor or otherwise be secured to the ground in a permanent or removable fashion. In some embodiments, a square receiver 102 can be attached (permanently or removably) to the floor of a work area to allow any device having an X-shaped adapter 101 to be mounted to the receiver. In this way, many different devices can be used in the work area without requiring their use directly on the floor, or requiring additional structure such as a workbench.

As another example, a square receiver 102 can be configured to mount to a structure such as a bench (e.g. via a clamp that is secured to the receiver), a beam of a wall structure or pole (e.g. via a square or rectangular shaped bracket), scaffolding (e.g. via a round or angled bracket), shelving (e.g. via appropriate hooks or tabs), etc. In these cases, the square receiver can be configured with appropriate extensions and components for mounting the receiver to the desired structure. In other cases, a square receiver can be directly welded or otherwise attached to a structure. In some cases, the structure to which the square receiver mounts can be mobile such as a vehicle or cart as is described in U.S. Provisional Patent Application No. 61/445,723, which is incorporated herein by reference.

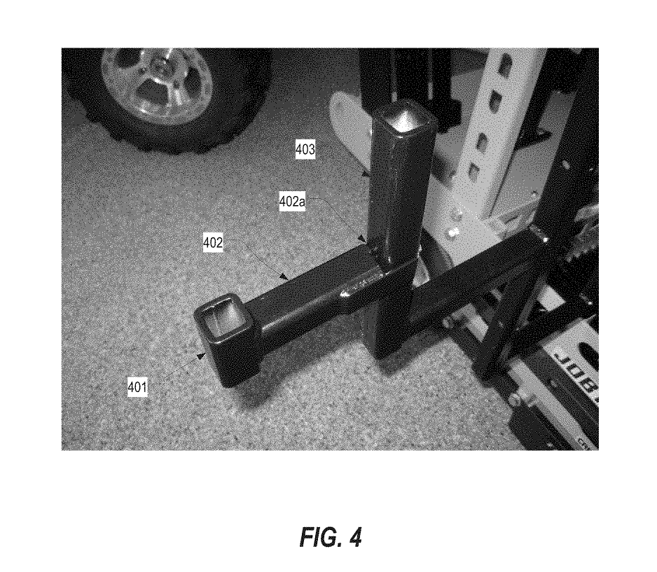

FIG. 4 provides one example of how a square receiver can be mounted to a structure. As shown, a square receiver 401 includes a support arm 402 having a square bracket 402a that bolts to a square pole 403. In this example, square pole 403 is also a square receiver. Accordingly, any device having an X-shaped adapter 101 could be mounted to either receiver 401 or the receiver formed by square pole 403.

Devices having X-shaped adapters can also include receiver extensions. For example, a receiver extension can be configured on one end with an X-shaped adapter 101 and at the other end with a square receiver 102. Such receiver extensions can be used to increase the height, change the angle, or otherwise alter the position of a square receiver. For example, a straight receiver extension could be used to increase the height of a square receiver, while a receiver extension having one or more bends or curves could be used to change the angle, height, and/or position of a square receiver.

One benefit of employing the mounting system of the present invention is that devices can easily be added and removed from a location. For example, a company may place a square receiver in a work area to allow many different devices to be used in the area during work hours. Then, at the close of business, the devices can be removed from the premises to minimize the risk of theft or injury that would otherwise be present if the devices were left out.

Similarly, the mounting system of the present invention facilitates the use of devices without requiring more permanent supporting structure or other accommodations. For example, if a project requires the use of various power tools that would otherwise require the use of a workbench or their use on the floor, a square receiver can be provided at an appropriate location so that the power tools can be supported off the floor without needing to build a more extensive or permanent structure.

To summarize, the present invention is directed to a mounting system that employs a square receiver and an X-shaped adapter for mounting many different devices to the square receiver. A square receiver can be positioned in virtually any location to allow devices to be mounted for use in a variety of settings and for a variety of purposes. Devices of various types and purposes can be configured to include an X-shaped adapter or to connect to another device having an X-shaped adapter. Suitable devices include tools of various types, device adapters, receiver extensions, canopies, work surfaces such as a work bench, etc.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A mounting system comprising:
a receiver having an opening; and
a device having an X-shaped adapter configured to be inserted into the opening of the receiver.

2. The mounting system of claim 1, wherein the opening has a square shape.

3. The mounting system of claim 2, wherein the X-shaped adapter aligns with corners of the square-shaped opening.

4. The mounting system of claim 1, wherein the receiver is configured to mount to a structure.

5. The mounting system of claim 4, wherein the receiver mounts to the structure via a bracket.

6. The mounting system of claim 5, wherein the bracket is one of square, rectangular, or round.

7. The mounting system of claim 1, wherein the device is one of:
a tool;
a device adapter;
a receiver extension;
a canopy; or
a work surface.

8. The mounting system of claim 1, wherein the device is a device adapter to which another device can be attached.

9. The mounting system of claim 1, wherein the device is a receiver extension that also includes a receiver having an opening into which a X-shaped adapter can be inserted.

10. The mounting system of claim 1, wherein the receiver is removably securable to a structure.

11. The mounting system of claim 10, wherein the structure is a vehicle.

12. The mounting system of claim 1, wherein the opening is rectangular.

13. A mounting system comprising:
a receiver having a square opening; and
a device having an elongated X-shaped adapter configured to be inserted into the square opening of the receiver when the X-shaped adapter is aligned with the corners of the opening.

14. The mounting system of claim 13, wherein the device is a tool.

15. The mounting system of claim 14, wherein the tool comprises a vice, a grinder, or a drill press.

16. The mounting system of claim 13, wherein an end of the X-shaped adapter is narrower than a base of the X-shaped adapter.

17. The mounting system of claim 13, wherein an end of the X-shaped adapter is tapered.

18. The mounting system of claim 13, wherein the receiver is mounted to a structure.

19. The mounting system of claim 13, wherein the structure is one of:
a post;
a wall beam;
a work bench;
a vehicle;
scaffolding; or
shelving.

20. A mounting system comprising:
a receiver having an opening; and
a universal mounting plate having an X-shaped adapter configured to be inserted into the opening of the receiver, the universal mounting plate being configured to allow the attachment of a plurality of devices thereto.
